(19) United States
(12) Patent Application Publication
(10) Pub. No.: US 2013/0154384 A1
(43) Pub. Date: Jun. 20, 2013

(54) CONTACTLESS POWER RECEIVING DEVICE, VEHICLE, CONTACTLESS POWER TRANSMITTING DEVICE, AND CONTACTLESS POWER SUPPLY SYSTEM

(71) Applicant: Koji NAKAMURA, Oobu-shi (JP)

(72) Inventor: Koji NAKAMURA, Oobu-shi (JP)

(21) Appl. No.: 13/687,691

(22) Filed: Nov. 28, 2012

(30) Foreign Application Priority Data
Dec. 15, 2011 (JP) 2011-274494

(51) Int. Cl. H01F 38/14

(52) U.S. Cl. CPC H01F 38/14
USPC 307/104

(57) ABSTRACT

A contactless power receiving device includes: a power receiving unit contactlessly receiving electric power from a power transmitting unit of a power transmitting device; and an electric load device using the electric power received by the power receiving unit. The power receiving unit includes: a coil; a capacitor connected to the coil; and a selector device connected in parallel with the capacitor and configured to be switched between a connecting state in which the selector device electrically connects both ends of the capacitor and a disconnecting state in which the selector device electrically disconnects the both ends of the capacitor.

### INCORPORATION BY REFERENCE

The disclosure of Japanese Patent Application No. 2011-274494 filed on Dec. 15, 2011 including the specification, drawings and abstract is incorporated herein by reference in its entirety.

### BACKGROUND OF THE INVENTION

1. Field of the Invention

The invention relates to a contactless power receiving device, a vehicle, a contactless power transmitting device, and a contactless power supply system.

2. Description of Related Art

In recent years, contactless wireless power transfer that does not use a power cord or a power transmission cable has become a focus of attention, and it has been suggested that the contactless wireless power transfer is applied to an electric vehicle, a hybrid vehicle, or the like, of which an in-vehicle electrical storage device is chargeable by a power supply outside the vehicle (hereinafter, also referred to as “external power supply”).

Japanese Patent Application Publication No. 2010-183812 (JP 2010-183812 A) describes that, in a vehicle of which an electrical storage device mounted on the vehicle is contactlessly chargeable by an external power supply, a plurality of power transfer coils (resonance coils) are arranged in at least one of a power transmitting device and a power receiving device (mobile unit) and then power transfer is carried out by selecting a combination of coils, having, a high power transfer efficiency.

When power transfer is carried out contactlessly in this way, the positional relationship between the power transmitting device and the power receiving device influences transfer efficiency. In JP 2010-183812 A, the plurality of coils used for power transfer are arranged in at least one of the power transmitting device and the power receiving device. Then, when power transfer is carried out, the coils having a high power transfer efficiency are selected. Therefore, accuracy required for a stop position of the power receiving device, which is the mobile unit, with respect to power transmitting device is relieved, and it is possible to efficiently carry out power transfer.

However, in JP 2010-183812 A, by changing a primary coil that supplies electric power to the resonance coil, the resonance coil that is used for power transfer is selected from among the plurality of resonance coils. In this case, at the time of carrying out power transfer, the non-selected resonance coil may electromagnetically interfere with the resonance coil that is carrying out power transfer and then influence power transfer. However, in JP 2010-183812 A, this point has not been considered.

### SUMMARY OF THE INVENTION

The invention provides a contactless power receiving device, vehicle, contactless power transmitting device and contactless power supply system that suppress influence on power transfer while appropriately selecting a coil that is used for power transfer.

A first aspect of the invention provides a contactless power receiving device. The contactless power receiving device includes: a power receiving unit that contactlessly receives electric power from a power transmitting unit included in a power transmitting device, and that includes: a first coil; a first capacitor that is connected to the first coil; and a first selector device that is connected in parallel with the first capacitor and that is configured to be switched between a connecting state in which the first selector device electrically connects both ends of the first capacitor and a disconnecting state in which the first selector device electrically disconnects the both ends of the first capacitor; and an electric load device that uses the electric power received by the power receiving unit.

A second aspect of the invention provides a contactless power transmitting device. The contactless power transmitting device includes: a power transmitting unit that contactlessly transmits electric power to a power receiving unit included in a power receiving device, and that includes: a fourth coil; a fourth capacitor that is connected to the fourth coil; and a fourth selector device that is connected in parallel with the fourth capacitor and that is configured to be switched between a connecting state in which the fourth selector device electrically connects both ends of the fourth capacitor and a disconnecting state in which the fourth selector device electrically disconnects the both ends of the fourth capacitor; and a power supply unit that supplies electric power to the power transmitting unit.

A third aspect of the invention provides a vehicle. The vehicle includes: a power receiving unit that contactlessly receives electric power from a power transmitting unit provided in a power transmitting device, and that includes: a coil; a capacitor that is connected to the coil; and a selector device that is connected in parallel with the capacitor and that is configured to be switched between a connecting state in which the selector device electrically connects both ends of the capacitor and a disconnecting state in which the selector device electrically disconnects the both ends of the capacitor; and an electric load device that uses the electric power received by the power receiving unit.

A fourth aspect of the invention provides a contactless power supply system. The contactless power supply system includes: a power transmitting unit that is provided in a power transmitting device and that includes a plurality of coil units; a power receiving unit that is provided in a vehicle; and a control unit, wherein: each of the plurality of coil units includes: a coil; a capacitor that is connected to the coil; and a selector device that is connected in parallel with the capacitor and that is configured to be switched between a connecting state in which the selector device electrically connects both ends of the capacitor and a disconnecting state in which the selector device electrically disconnects the both ends of the capacitor; the control unit selects at least one of the coil units, which is used to transmit electric power, from among the plurality of coil units on the basis of a position of the power transmitting unit and a position of the power receiving unit; and the control unit executes control such that the selector device corresponding to the at least one selected coil unit is set in the disconnecting state and the selector device corresponding to the non-selected coil unit is set in the connecting state.

A fifth aspect of the invention provides a contactless power supply system. The contactless power supply system includes: a power transmitting unit that is provided in a power transmitting device; a power receiving unit that is provided in a vehicle and that includes a plurality of coil units; and a control unit, wherein: each of the plurality of coil units includes: a coil; a capacitor that is connected to the coil; and a selector device that is connected in parallel with the capacitor and that is configured to be switched between a connecting state in which the selector device electrically connects both ends of the capacitor and a disconnecting state in which the selector device electrically disconnects the both ends of the capacitor; the control unit selects at least one of the coil units, which is used to receive electric power, from among the plurality of coil units on the basis of a position of the power transmitting unit and a position of the power receiving unit; and the control unit executes control such that the selector device corresponding to the at least one selected coil unit is set in the disconnecting state and the selector device corresponding to the non-selected coil unit is set in the connecting state.

With the above-described configurations, in the contactless power supply system that contactlessly carries out power transfer from the power transmitting device to the power receiving device, it is possible to suppress influence on power transfer while appropriately selecting the coil that is used for power transfer.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall configuration diagram of a vehicle power supply system according to a first embodiment of the invention;

FIG. 2 is a functional block diagram that illustrates the detailed configuration of a vehicle and power transmitting device shown in FIG. 1;

FIG. 3 is an equivalent circuit diagram at the time of power transfer from the power transmitting device to the vehicle;

FIG. 4 is a view that shows a simulation model of a power transfer system;

FIG. 5 is a graph that shows the correlation between a difference in natural frequency of each of a power transmitting unit and a power receiving unit and a power transfer efficiency;

FIG. 6 is a graph that shows the correlation between a power transfer efficiency at the time when an air gap is varied and the frequency of a current that is supplied to the power transmitting unit in a state where the natural frequency is fixed;

FIG. 7 is a graph that shows the correlation between a distance from a current source (magnetic current source) and the strength of an electromagnetic field;

FIG. 8 is a view that shows an equivalent circuit of a coil unit and mathematical expressions expressing a resonance frequency and a Q value in the case where the coil unit is not used (not selected) for power transfer;

FIG. 9 is a view that shows an equivalent circuit of the coil unit and mathematical expressions expressing a resonance frequency and a Q value in the case where the coil unit is used (selected) for power transfer;

FIG. 10 is a flowchart for illustrating coil selection control that is executed by an ECU according to the first embodiment;

FIG. 11 is a view that shows mathematical expressions expressing a resonance frequency and a Q value when a coil unit having a plurality of capacitors and a plurality of switches is not selected according to an alternative embodiment;

FIG. 12 is a view that shows mathematical expressions expressing a resonance frequency and a Q value when a coil unit having a plurality of capacitors and a plurality of switches is selected according to the alternative embodiment;

FIG. 13 is a view for illustrating the outline of coil selection control in the case where a power transmitting device includes a plurality of power transmitting coils according to a second embodiment; and

FIG. 14 is a flowchart for illustrating the coil selection control that is executed by an ECU according to the second embodiment.

### DETAILED DESCRIPTION OF EMBODIMENTS

Hereinafter, embodiments of the invention will be described in detail with reference to the accompanying drawings. Note that like reference numerals denote the same or corresponding components in the drawings, and the description thereof is not repeated.

### First Embodiment

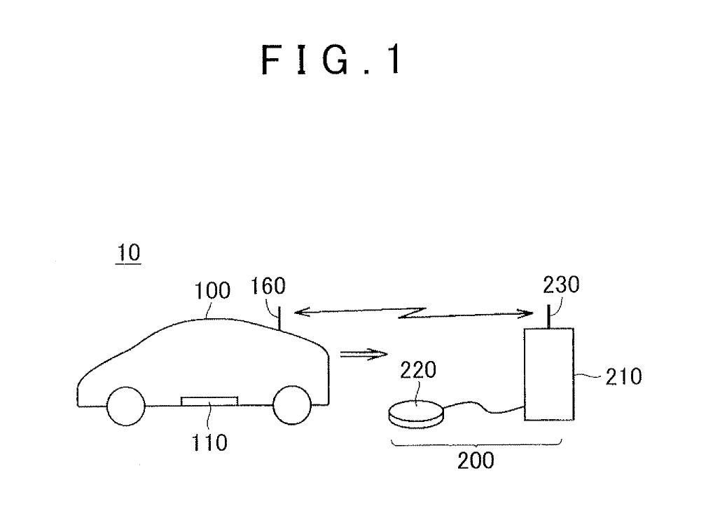

FIG. 1 is an overall configuration diagram of a vehicle power supply system according to a first embodiment of the invention. As shown in FIG. 1, the vehicle power supply system 10 includes a vehicle 100 and a power transmitting device 200. The vehicle 100 includes a power receiving unit 110 and a communication unit 160.

The power receiving unit 110 is installed at a vehicle body bottom face, and contactlessly receives high-frequency alternating-current power via an electromagnetic field. The high-frequency alternating-current power is output from a power transmitting unit 220 (described later) of the power transmitting device 200. Note that the configuration of the power receiving unit 110 will be described later together with the configuration of the power transmitting unit 220 and power transfer from the power transmitting unit 220 to the power receiving unit 110. The communication unit 160 is a communication interface by which the vehicle 100 carries out communication with the power transmitting device 200.

The power transmitting device 200 includes a power supply device 210, the power transmitting unit 220, and a communication unit 230. The power supply device 210 generates alternating-current power having a predetermined frequency. For example, the power supply device 210 generates high-frequency alternating-current power upon reception of electric power from a system power supply (not shown), and supplies the generated alternating-current power to the power transmitting unit 220.

The power transmitting unit 220 is installed at a floor face of a parking space, and receives high-frequency alternating-current power supplied from the power supply device 210. Then, the power transmitting unit 220 contactlessly transfers electric power to the power receiving unit 110 of the vehicle 100 via an electromagnetic field that is generated around the power transmitting unit 220. Note that the configuration of the power transmitting unit 220 will also be described later together with the configuration of the power receiving unit 110 and power transfer from the power transmitting unit 220 to the power receiving unit 110. The communication unit 230 is a communication interface by which the power transmitting device 200 carries out communication with the vehicle 100.

In the vehicle power supply system 10, electric power is contactlessly transferred from the power transmitting unit 220 of the power transmitting device 200 to the power receiving unit 110 of the vehicle 100. In order to efficiently transfer electric power from the power transmitting device 200 to the vehicle 100, it is required to accurately match the position of the power receiving unit 110 with the position of the power transmitting unit 220.

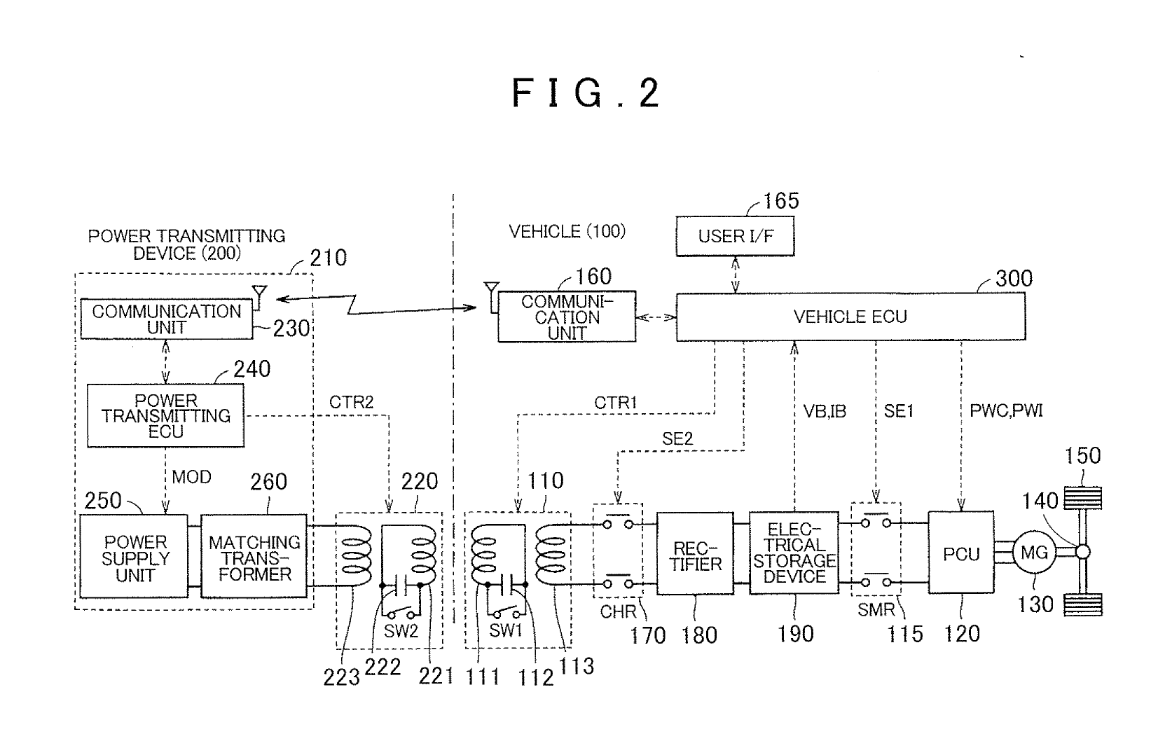

FIG. 2 is a detailed configuration diagram of the power supply system 10 shown in FIG. 1. As shown in FIG. 2, the power transmitting device 200 includes the power supply device 210 and the power transmitting unit 220 as described above. The power supply device 210 further includes a power transmitting ECU 240, a power supply unit 250 and a matching transformer 260 in addition to the communication unit 230. The power transmitting ECU 240 functions as a control unit. The power transmitting unit 220 includes a power transmitting resonance coil 221, a power transmitting capacitor 222, a power transmitting electromagnetic induction coil 223, and a power transmitting switch SW2. The power transmitting switch SW2 functions as a selector device that is connected in parallel with the power transmitting capacitor 222.

The power supply unit 250 is, controlled by a control signal MOD from the power transmitting ECU 240, and converts electric power, received from the alternating-current power supply, such as a commercial power supply, to high-frequency electric power. Then, the power supply unit 250 supplies the converted high-frequency electric power to the electromagnetic induction coil 223 via the matching transformer 260.

The matching transformer 260 is a circuit for matching impedance between the power transmitting device 200 and the vehicle 100. The matching transformer 260 is provided between the power supply unit 250 and the power transmitting unit 220, and is configured to change internal impedance. For example, the matching transformer 260 is formed of a variable capacitor and a coil (not shown). In this case, it is possible to change the impedance of the matching transformer 260 by varying the capacitance of the variable capacitor. By changing the impedance of the matching transformer 260, it is possible to match the impedance of the power transmitting device 200 with the impedance of the vehicle 100 (impedance matching). Note that, in FIG. 2, the matching transformer 260 is provided separately from the power supply unit 250; instead, the power supply unit 250 may include the function of the matching transformer 260.

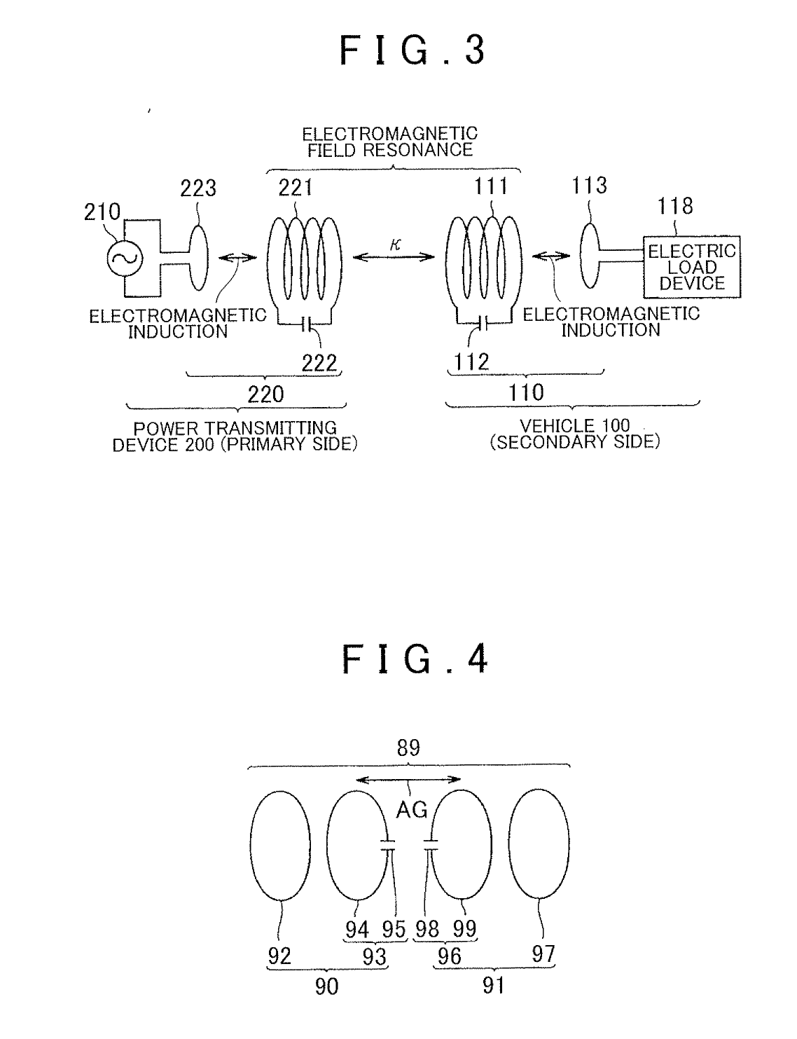

The power transmitting resonance coil 221 contactlessly transfers electric power to a power receiving resonance coil 111, included in the power receiving unit 110 of the vehicle 100. Note that power transfer between the power receiving unit 110 and the power transmitting unit 220 will be described later with reference to FIG. 3.

As described above, the communication unit 230 is a communication interface for carrying out wireless communication between the power transmitting device 200 and the vehicle 100. The communication unit 230 receives vehicle information and a signal for instructions to start or stop transmission of electric power, which is transmitted from the communication unit 160 of the vehicle 100, and outputs these pieces of information to the power transmitting ECU 240.

The power transmitting ECU 240 includes a central processing unit (CPU), a storage device and an input/output buffer (which are not shown in FIG. 1). The power transmitting ECU 240 receives signals from sensors, or the like, and outputs control signals to various devices to thereby control various devices in the power supply device 210. Note that control over the vehicle 100 and the devices is not only limited to software processing but may also be processed by exclusive hardware (electronic circuit). In addition, the power transmitting ECU 240 controls the power transmitting switch SW2 included in the power transmitting unit 220 on the basis of a control signal CTR2.

The vehicle 100 includes a charging relay (CHR) 170, a rectifier 180, an electrical storage device 190, a system main relay (SMR) 115, a power control unit (PCU) 120, a motor generator 130, a power transmission gear 140, drive wheels 150, a vehicle electronic control unit (ECU) 300 that functions as a control unit, and a user interface (I/F) 165 in addition to the power receiving unit 110 and the communication unit 160. The power receiving unit 110 includes the power receiving resonance coil 111, a power receiving capacitor 112, a power receiving electromagnetic induction coil 113, and a power receiving switch SW1. The power receiving switch SW1 functions as a selector device that is connected in parallel with the power receiving capacitor 112.

Note that, in the present embodiment, the vehicle 100 is, for example, described as an electric vehicle; however, the configuration of the vehicle 100 is not limited to the electric vehicle as long as the vehicle is able to travel using electric power stored in the electrical storage device. Another example of the vehicle 100 may be a hybrid vehicle equipped with an engine, a fuel cell vehicle equipped with a fuel cell, or the like.

The power receiving resonance coil 111 contactlessly receives electric power from the power transmitting resonance coil 221 included in the power transmitting device 200.

The rectifier 180 rectifies alternating-current power received from the power receiving electromagnetic induction coil 113 via the CHR 170, and outputs the rectified direct-current power to the electrical storage device 190. The rectifier 180 may be, for example, formed to include a diode bridge and a smoothing capacitor (both are not shown). The rectifier 180 may be a so-called switching regulator that rectifies alternating current using switching control; however, the rectifier 180 may be included in the power receiving unit 110, and, in order to prevent erroneous operation, or the like, of switching elements due to a generated electromagnetic field, the rectifier 180 is desirably a static rectifier, such as a diode bridge.

The CHR 170 is electrically connected between the power receiving unit 110 and the rectifier 180. The CHR 170 is controlled by a control signal SE2 from the vehicle ECU 300, and switches between supply and interruption of electric power from the power receiving unit 110 to the rectifier 180.

The electrical storage device 190 is an electric power storage element that is configured to be chargeable and dischargeable. The electrical storage device 190 is, for example, formed of a secondary battery, such as a lithium ion battery, a nickel-metal hydride battery and a lead-acid battery, or an electrical storage element, such as an electric double layer capacitor.

The electrical storage device 190 is connected to the rectifier 180, and stores electric power received by the power receiving unit 110 and rectified by the rectifier 180. In addition, the electrical storage device 190 is also connected to the PCU 120 via the SMR 115. The electrical storage device 190 supplies electric power for generating vehicle driving force to the PCU 120. Furthermore, the electrical storage device 190 stores electric power generated by the motor generator 130. The output of the electrical storage device 190 is, for example, about 200 V.

A voltage sensor and a current sensor (both are not shown) are provided for the electrical storage device 190. The voltage sensor is used to detect the voltage VB of the electrical storage device 190. The current sensor is used to detect a current IB input to or output from the electrical storage device 190. These detected values are output to the vehicle ECU 300. The vehicle ECU 300 computes the state of charge (also referred to as “SOC”) of the electrical storage device 190 on the basis of the voltage VB and the current TB.

The SMR 115 is electrically connected between the electrical storage device 190 and the PCU 120. The SMR 115 is controlled by a control signal SE1 from the vehicle ECU 300, and switches between supply and interruption of electric power between the electrical storage device 190 and the PCU 120.

The PCU 120 includes a converter and an inverter (both are not shown). The converter is controlled by a control signal PWC from the vehicle ECU 300, and converts voltage from the electrical storage device 190. The inverter is controlled by a control signal PWT from the vehicle ECU 300, and drives the motor generator 130 using electric power converted by the converter.

The motor generator 130 is an alternating-current rotating electrical machine, and is, for example, a permanent-magnet synchronous motor that includes a rotor in which a permanent magnet is embedded.

The output torque of the motor generator 130 is transmitted to the drive wheels 150 via the power transmission gear 140 to drive the vehicle 100. The motor generator 130 is able to generate electric power using the rotational force of the drive wheels 150 during regenerative braking operation of the vehicle 100. Then, the generated electric power is converted by the PCU 120 to charging electric power to charge the electrical storage device 190.

In addition, in a hybrid vehicle equipped with an engine (not shown) in addition to the motor generator 130, the engine and the motor generator 130 are cooperatively operated to generate required vehicle driving force. In this case, the electrical storage device 190 may be charged with electric power generated through the rotation of the engine.

As described above, the communication unit 160 is a communication interface for carrying out wireless communication between the vehicle 100 and the power transmitting device 200. The communication unit 160 outputs vehicle information from the vehicle ECU 300 to the power transmitting device 200. In addition, the communication unit 160 outputs a signal, which instructs the power transmitting device 200 to start or stop transmission of electric power, to the power transmitting device 200.

The user interface 165 receives user operation or outputs information to the user. The user interface 165, for example, receives a command to start external charging through user's operation. In addition, the user interface 165 provides the user with positional information between the power receiving unit 110 and the power transmitting unit 220 and information about the state of charge of the electrical storage device 190, and the like.

The vehicle ECU 300 includes a CPU, a storage unit and an input/output buffer, which are not shown in FIG. 1. The vehicle ECU 300 receives signals from the sensors, and the like, outputs control signals to the devices, and controls the devices in the vehicle 100. Note that control over the devices are not only limited to software processing but may also be processed by exclusive hardware (electronic circuit). In addition, the vehicle ECU 300 controls the power receiving switch SW1 included in the power receiving unit 110 on the basis of a control signal CTR1.

Next, power transfer from the power transmitting device 200 to the vehicle 100 will be described. FIG. 3 is an equivalent circuit diagram at the time of power transfer from the power transmitting device 200 to the vehicle 100. As shown in FIG. 3, the power transmitting unit 220 of the power transmitting device 200 includes the power transmitting electromagnetic induction coil 223, the power transmitting resonance coil 221 and the power transmitting capacitor 222.

The power transmitting electromagnetic induction coil 223 is, for example, provided substantially coaxially with the resonance coil 221 at a predetermined gap from the power transmitting resonance coil 221. The power transmitting electromagnetic induction coil 223 is magnetically coupled to the power transmitting resonance coil 221 through electromagnetic induction, and supplies high-frequency electric power, which is supplied from the power supply device 210, to the power transmitting resonance coil 221 through electromagnetic induction.

The power transmitting resonance coil 221 forms an LC resonance circuit together with the power transmitting capacitor 222. Note that, as will be described later, an LC resonance circuit is also formed in the power receiving unit 110 of the vehicle 100. The difference between the natural frequency of the LC resonance circuit formed of the power transmitting resonance coil 221 and the power transmitting capacitor 222 and the natural frequency of the LC resonance circuit of the power receiving unit 110 is smaller than or equal to ±10% of the natural frequency of any one of the former LC resonance circuit and the latter LC resonance circuit. Then, the power transmitting resonance coil 221 receives electric power from the power transmitting electromagnetic induction coil 223 through electromagnetic induction, and contactlessly transmits electric power to the power receiving unit 110 of the vehicle 100.

The electromagnetic induction coil 223 is provided in order to easily supply electric power from the power supply device 210 to the power transmitting resonance coil 221. The power supply device 210 may be directly connected to the power transmitting resonance coil 221 without providing the power transmitting electromagnetic induction coil 223. In addition, the power transmitting capacitor 222 is provided in order to adjust the natural frequency of the resonance circuit. When a desired natural frequency is obtained by utilizing the stray capacitance of the power transmitting resonance coil 221, it is not necessary to provide the power transmitting capacitor 222.

The power receiving unit 110 of the vehicle 100 includes the power receiving resonance coil 111, the power receiving capacitor 112 and the power receiving electromagnetic induction coil 113. The power receiving resonance coil 111 forms an LC resonance circuit together with the power receiving capacitor 112. As described above, the difference between the natural frequency of the LC resonance circuit formed of the power receiving resonance coil 111 and the power receiving capacitor 112 and the natural frequency of the LC resonance circuit formed of the power receiving resonance coil 221 and the power receiving capacitor 222 in the power transmitting unit 220 of the power transmitting device 200 is smaller than or equal to ±10% of the natural frequency, of any one of the former LC resonance circuit and the latter LC resonance circuit. The power receiving resonance coil 111 contactlessly receives electric power from the power transmitting unit 220 of the power transmitting device 200.

The electromagnetic induction coil 113 is, for example, provided substantially coaxially with the power receiving resonance coil 111 at a predetermined gap from the power receiving resonance coil 111. The power receiving electromagnetic induction coil 113 is magnetically coupled to the power receiving resonance coil 111 through electromagnetic induction, extracts electric power, received by the power receiving resonance coil 111, through electromagnetic induction, and outputs the extracted electric power to an electric load device 118. Here, the electric load device 118 collectively indicates electrical devices downstream of the rectifier 180 (FIG. 2).

The power receiving electromagnetic induction coil 113 is provided in order to easily extract electric power from the power receiving resonance coil 111. The rectifier 180 may be directly connected to the power receiving resonance coil 111 without providing the power receiving electromagnetic induction coil 113. In addition, the power receiving capacitor 112 is provided in order to adjust the natural frequency of the resonance circuit. When a desired natural frequency is obtained by utilizing the stray capacitance of the power receiving resonance coil 111, it is not necessary to provide the power receiving capacitor 112.

In the power transmitting device 200, high-frequency alternating-current power is supplied from the power supply device 210 to the power transmitting electromagnetic induction coil 223, and electric power is supplied from the power transmitting electromagnetic induction coil 223 to the power transmitting resonance coil 221. By so doing, energy (electric power) is transferred from the power transmitting resonance coil 221 to the power receiving resonance coil 111 through a magnetic field formed between the power transmitting resonance coil 221 and the power receiving resonance coil 111 of the vehicle 100. Energy (electric power) transferred to the power receiving resonance coil 111 is extracted with the use of the power receiving electromagnetic induction coil 113, and is transferred to the electric load device 118 of the vehicle 100.

As described above, in the power transfer system, the difference between the natural frequency of the power transmitting unit 220 of the power transmitting device 200 and the natural frequency of the power receiving unit 110 of the vehicle 100 is smaller than, or equal to ±10% of the natural frequency of one of the power transmitting unit 220 and the power receiving unit 110. By setting the natural frequency of each of the power transmitting unit 220 and the power receiving unit 110 within the above range, it is possible to increase the power transfer efficiency. On the other hand, when the above-described difference in natural frequency is larger than ±10%, the power transfer efficiency becomes lower than 10%, so there occurs an inconvenience, such as an increase in the duration of a power transfer time.

The natural frequency of the power transmitting unit 220 (power receiving unit 110) means an oscillation frequency in the case where the electric circuit (resonance circuit) that constitutes the power transmitting unit 220 (power receiving unit 110) freely oscillates. Note that, in the electric circuit (resonance circuit) that constitutes the power transmitting unit 220 (power receiving unit 110), the natural frequency at the time when braking force or electrical resistance is substantially zero is also called the resonance frequency of the power transmitting unit 220 (power receiving unit 110).

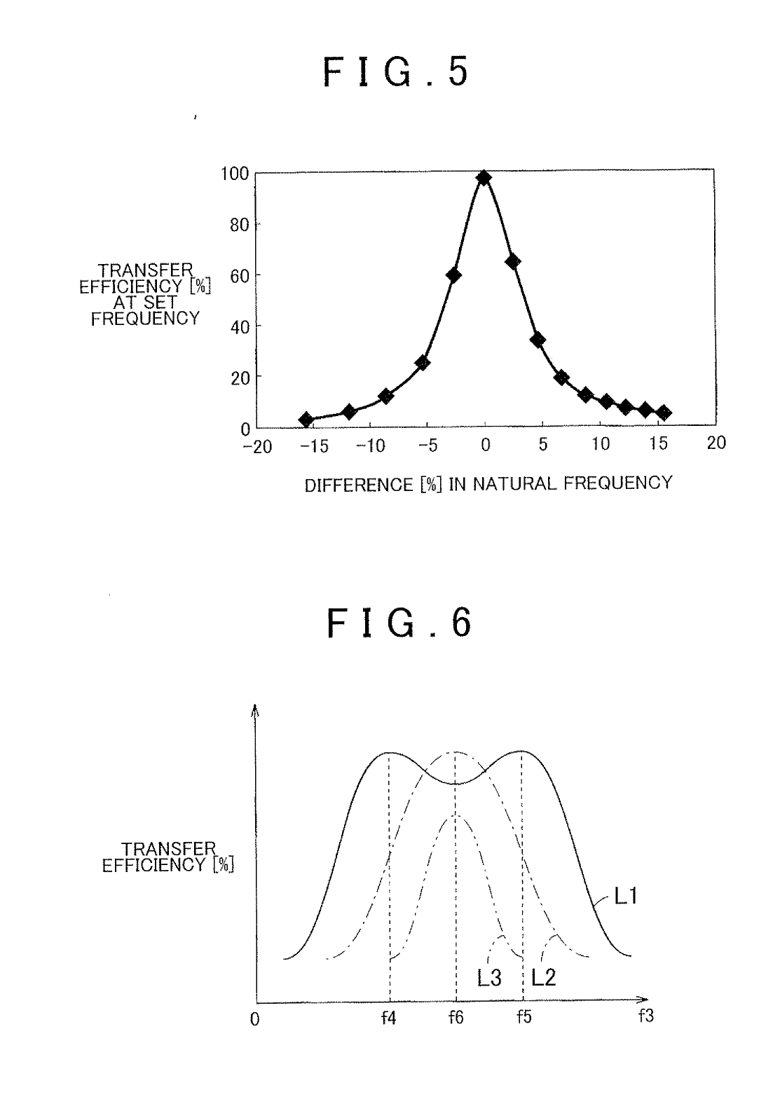

The simulation result obtained by analyzing the correlation between a difference in natural frequency and a power transfer efficiency will be described with reference to FIG. 4 and FIG. 5. FIG. 4 is a view that shows a simulation model of a power transfer system. In addition, FIG. 5 is a graph that shows the correlation between a difference in the natural frequency of each of the power transmitting unit and the power receiving unit and a power transfer efficiency.

As shown in FIG. 4, the power transfer system 89 includes a power transmitting unit 90 and a power receiving unit 91. The power transmitting unit 90 includes a first coil 92 and a second coil 93. The second coil 93 includes a resonance coil 94 and a capacitor 95 that is provided in the resonance coil 94. The power receiving unit 91 includes a third coil 96 and a fourth coil 97. The third coil 96 includes a resonance coil 99 and a capacitor 98 that is connected to the resonance coil 99.

The inductance of the resonance coil 94 is set to Lt, and the capacitance of the capacitor 95 is set to C1. In addition, the inductance of the resonance coil 99 is set to Lr, and the capacitance of the capacitor 98 is set to C2. When the parameters are set in this way, the natural frequency f1 of the second coil 93 is expressed by the following mathematical expression (1), and the natural frequency f2 of the third coil 96 is expressed by the following mathematical expression (2).

f1=1/{2π(Lt×C1)^{1/2}} (1)

f2=1/{2π(Lr×C2)^{1/2}} (2)

Here, in the case where the inductance Lr and the capacitances C1 and C2 are fixed and only the inductance Lt is varied, the correlation between a difference in natural frequency between the second coil 93 and the third coil 96 and a power transfer efficiency is shown in FIG. 5. Note that, in this simulation, a relative positional relationship between the resonance coil 94 and the resonance coil 99 is fixed, and, furthermore, the frequency of current that is supplied to the second coil 93 is constant.

As shown in FIG. 5, the abscissa axis represents a difference Df (%) in natural frequency, and the ordinate axis represents a power transfer efficiency (%) with a current having a set frequency. The difference Df (%) in natural frequency is expressed by the following mathematical expression (3).

Df{(f1−f2)/f2}×100 (3)

As is apparent from FIG. 5, when the difference Df (%) in natural frequency is 0%, the power transfer efficiency is close to 100%. When the difference Df (%) in natural frequency is ±5%, the power transfer efficiency is about 40%. When the difference Df (%) in natural frequency is ±10%, the power transfer efficiency is about 10%. When the difference Df (%) in natural frequency is ±15%, the power transfer efficiency is about 5%. That is, it is found that, by setting the natural frequency of each of the second coil 93 and the third coil 96 such that the absolute value of the difference Df (%) in natural frequency (difference in natural frequency) falls at or below 10% of the natural frequency of the third coil 96, it is possible to increase the power transfer efficiency to a practical level. Furthermore, by setting the natural frequency of each of the second coil 93 and the third coil 96 such that the absolute value of the difference Df (%) in natural frequency is smaller than or equal to 5% of the natural frequency of the third coil 96, it is possible to further increase the power transfer efficiency, so it is more desirable. Note that the electromagnetic field analyzation software application (JMAG (trademark): produced by JSOL Corporation) is employed as a simulation software application.

Referring back to FIG. 2, the power transmitting unit 220 of the power transmitting device 200 and the power receiving unit 110 of the vehicle 100 contactlessly exchange electric power through at least one of a magnetic field and an electric field. The magnetic field is formed between the power transmitting unit 220 and the power receiving unit 110, and oscillates at a specific frequency. The electric field is formed between the power transmitting unit 220 and the power receiving unit 110, and oscillates at a specific frequency. A coupling coefficient K between the power transmitting unit 220 and the power receiving unit 110 is desirably smaller than or equal to 0.1. By resonating the power transmitting unit 220 and the power receiving unit 110 through the electromagnetic field, electric power is transferred from the power transmitting unit 220 to the power receiving unit 110.

Here, the magnetic field having the specific frequency, which is formed around the power transmitting unit 220, will be described. The “magnetic field having the specific frequency” typically correlates with the power transfer efficiency and the frequency of current that is supplied to the power transmitting unit 220. Then, first, the correlation between the power transfer efficiency and the frequency of current that is supplied to the power transmitting unit 220 will be described. The power transfer efficiency at the time when electric power is transferred from the power transmitting unit 220 to the power receiving unit 110 varies depending on various factors, such as a distance between the power transmitting unit 220 and the power receiving unit 110. For example, the natural frequency (resonance frequency) of each of the power transmitting unit 220 and the power receiving unit 110 is set to f0, the frequency of current that is supplied to the power transmitting unit 220 is set to f3, and the air gap between the power transmitting unit 220 and the power receiving unit 110 is set to AG.

FIG. 6 is a graph that shows the correlation between a power transfer efficiency and the frequency f3 of current that is supplied to the power transmitting unit 220 at the time when the air gap AG is varied in a state where the natural frequency ID is fixed. In FIG. 6, the abscissa axis represents the frequency f3 of current that is supplied to the power transmitting unit 220, and the ordinate axis represents a power transfer efficiency (%). An efficiency curve L1 schematically shows the correlation between a power transfer efficiency and the frequency f3 of current that is supplied to the power transmitting unit 220 when the air gap AG is small. As indicated by the efficiency curve L1, when the air gap AG is small, the peak of the power transfer efficiency appears at frequencies f4 and f5 (f4<f5). When the air gap AG is increased, two peaks at which the power transfer efficiency is high vary so as to approach each other. Then, as indicated by an efficiency curve L2, when the air gap AG is increased to be longer than a predetermined distance, the number of the peaks of the power transfer efficiency is one, the power transfer efficiency becomes a peak when the frequency of current that is supplied to the power transmitting unit 220 is a frequency f6. When the air gap AG is further increased from the state of the efficiency curve L2, the peak of the power transfer efficiency reduces as indicated by an efficiency curve L3.

For example, the following first and second methods are conceivable as a method of improving the power transfer efficiency. In the first method, by varying the capacitances of the capacitor 222 and capacitor 112 in accordance with the air gap AG while the frequency of current that is supplied to the power transmitting unit 220 is constant, the characteristic of power transfer efficiency between the power transmitting unit 220 and the power receiving unit 110 is varied. Specifically, the capacitances of the capacitor 222 and capacitor 112 are adjusted such that the power transfer efficiency becomes a peak in a state where the frequency of current that is supplied to the power transmitting unit 220 is constant. In this method, irrespective of the size of the air gap AG, the frequency of current flowing through the power transmitting unit 220 and the power receiving unit 110 is constant. As a method of varying the characteristic of power transfer efficiency, a method of utilizing the matching transformer 260 of the power transmitting device 200, a method of utilizing a converter (not shown) provided between the rectifier 180 and the electrical storage device 190 in the vehicle 100, or the like, may be employed.

In addition, in the second method, the frequency of current that is supplied to the power transmitting unit 220 is adjusted on the basis of the size of the air gap AG. For example, when the power transfer characteristic becomes the characteristic indicated by the efficiency curve L1, current having the frequency f4 or the frequency f5 is supplied to the power transmitting unit 220. When the frequency characteristic becomes the characteristic indicated by the efficiency curve L2 or L3, current having the frequency f6 is supplied to the power transmitting unit 220. In this case, the frequency of current flowing through the power transmitting unit 220 and the power receiving unit 110 is varied in accordance with the size of the air gap AG.

In the first method, the frequency of current flowing through the power transmitting unit 220 is a fixed constant frequency, and, in the second method, the frequency of current flowing through the power transmitting unit 220 is a frequency that appropriately varies with the air gap AG. Through the first method, the second method, or the like, current having the specific frequency set such that the power transfer efficiency is high is supplied to the power transmitting unit 220. When current having the specific frequency flows through the power transmitting unit 220, a magnetic field (electromagnetic field) that oscillates at the specific frequency is formed around the power transmitting unit 220. The power receiving unit 110 receives electric power from the power transmitting unit 220 through the magnetic field that is formed between the power receiving unit 110 and the power transmitting unit 220 and that oscillates at the specific frequency. Thus, the “magnetic field that oscillates at the specific frequency” is not necessarily a magnetic field having a fixed frequency. Note that, in the above-described embodiment, the frequency of current that is supplied to the power transmitting unit 220 is set by focusing on the air gap AG; however, the power transfer efficiency also varies on the basis of other factors, such as a deviation in the horizontal position between the power transmitting unit 220 and the power receiving unit 110, so the frequency of current that is supplied to the power transmitting unit 220 may possibly be adjusted on the basis of those other factors.

The above description is made on the example in which a helical coil is employed as each resonance coil; however, when a meander line antenna, or the like, is employed as each resonance coil, current having the specific frequency flows through the power transmitting unit 220, and, therefore, an electric field having the specific frequency is formed around the power transmitting unit 220. Then, through the electric field, power is transferred between the power transmitting unit 220 and the power receiving unit 110.

In the power transfer system, a near field (evanescent field) in which the electrostatic field of an electromagnetic field is dominant is utilized. By so doing, power transmitting and power receiving efficiencies are improved.

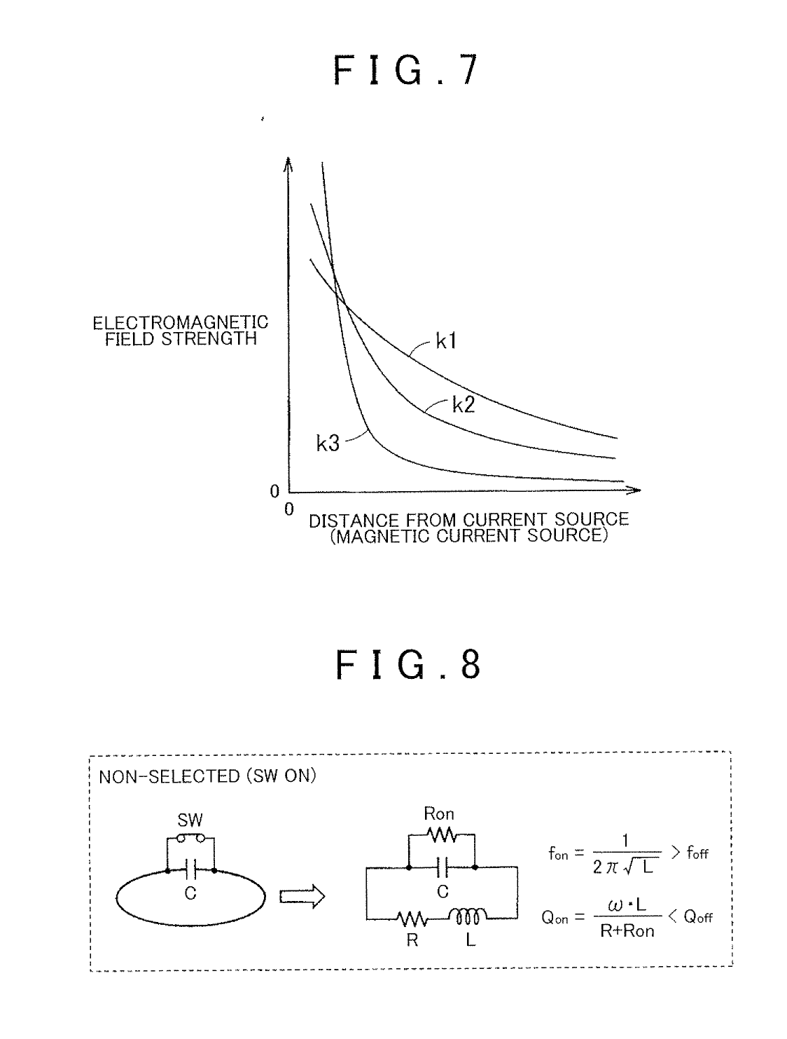

FIG. 7 is a graph that shows the relationship between the distance from a current source (magnetic current source) and the strength of electromagnetic field. As shown in FIG. 7, the electromagnetic field consists of three components. The curve k1 is a component that is inversely proportional to the distance from a wave source, and is called radiation electromagnetic field. The curve k2 is a component that is inversely proportional to the square of the distance from the wave source, and is called induction electromagnetic field. In addition, the curve k3 is a component that is inversely proportional to the cube of the distance from the wave source, and is called static electromagnetic field. Where the wavelength of the electromagnetic field is λ, a distance at which the strengths of the radiation electromagnetic field, induction electromagnetic field and static electromagnetic field are substantially equal to one another may be expressed as λ/2π.

The static electromagnetic field is a region in which the strength of electromagnetic wave steeply decreases with an increase in distance from the wave source. In the power transfer system according to the first embodiment, transfer of energy (electric power) is performed by utilizing the near field (evanescent field) in which the static electromagnetic field is dominant. That is, by resonating the power transmitting unit 220 and the power receiving unit 110 (for example, a pair of LC resonance coils) having the close natural frequencies in the near field in which the static electromagnetic field is dominant, energy (electric power) is transferred from the power transmitting unit 220 to the other power receiving unit 110. The static electromagnetic field does not propagate energy over a long distance, so the resonance method is able to transmit electric power with less loss of energy in comparison with an electromagnetic wave that transmits energy (electric power) through the radiation electromagnetic field that propagates energy over a long distance.

In this way, in the power transfer system, by resonating the power transmitting unit 220 and the power receiving unit 110 through the electromagnetic field, electric power is contactlessly transferred between the power transmitting unit 220 and the power receiving unit 110. Then, a coupling coefficient K between the power transmitting unit 220 and the power receiving unit 110 is desirably smaller than or equal to 0.1. The coupling coefficient K is not limited to this value; it may be various values at which power transfer is good. Generally, in power transfer that utilizes electromagnetic induction, the coupling coefficient K between the power transmitting unit and the power receiving unit is close to 1.0.

Coupling between the power transmitting unit 220 and the power receiving unit 110 in power transfer is called magnetic resonance coupling, magnetic field resonance coupling, electromagnetic field resonance coupling or electric field resonance coupling. The electromagnetic field resonance coupling means coupling that includes the magnetic resonance coupling, the magnetic field resonance coupling and the electric field resonance coupling.

When the power transmitting unit 220 and the power receiving unit 110 are formed of coils as described above, the power transmitting unit 220 and the power receiving unit 110 are mainly coupled through a magnetic field, and magnetic resonance coupling or magnetic field resonance coupling is formed. For example, an antenna, such as a meander line antenna, may be employed as each of the power transmitting unit 220 and the power receiving unit 110. In this case, the power transmitting unit 220 and the power receiving unit 110 are mainly coupled through an electric field, and electric field resonance coupling is formed.

In the above-described power transfer system, when the electromagnetic field corresponding to the natural frequency of each resonance coil is applied to each resonance coil, power transfer is carried out in response to the application of the electromagnetic field. However, in the case where it is not actually required to carry out power transfer, for example, when electric power is supplied from the power supply unit 250 to the power transmitting unit 220 in the power transmitting device 200 shown in FIG. 2 in a state where there is no power receiving vehicle 100, an electromagnetic field is generated by the power transmitting unit 220, so an electromagnetic field may be unnecessarily leaked to surroundings.

In addition, in the vehicle 100 as well, in the case where it is not required to charge the electrical storage device 190, when an electromagnetic field is generated by the power transmitting device 200, power is unnecessarily received in the power receiving unit 110, so energy may be stored in the power receiving unit. For example, in the case where electric power is transferred to a plurality of power receiving devices (vehicles) with the use of a common power transmitting unit, it is desirable that only a vehicle that needs to be charged is allowed to receive electric power.

Then, in the first embodiment, only when it is required to actually carry out power transfer, coil selection control is executed such that the resonance coil of the power transmitting unit transmits electric power or the resonance coil of the power receiving unit receives electric power.

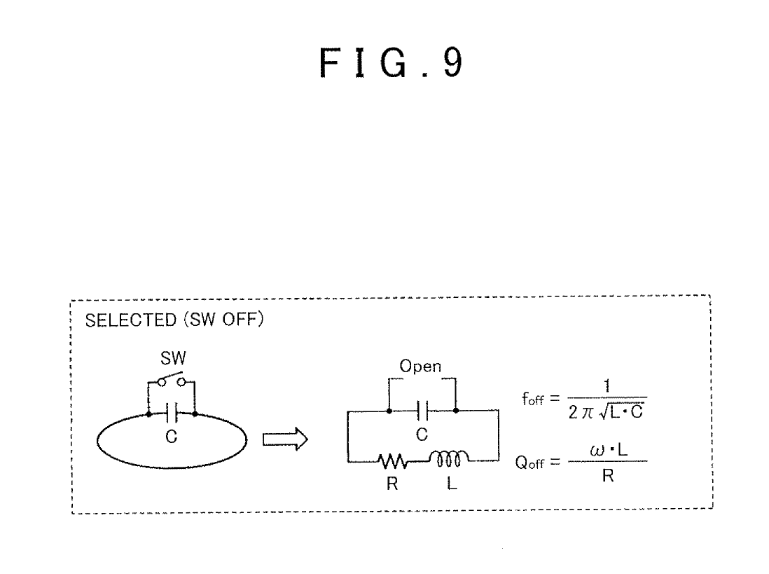

The outline of the coil selection control according to the first embodiment will be described with reference to FIG. 8 and FIG. 9. FIG. 8 is a view that shows an equivalent circuit of a coil unit and mathematical expressions expressing a resonance frequency and a Q value in the case where the coil unit is not used (not selected) for power transfer. In addition, FIG. 9 is a view that shows an equivalent circuit of the coil unit and mathematical expressions expressing a resonance frequency and a Q value in the case where the coil unit is used (selected) for power transfer.

As shown in FIG. 8, when the coil is not used for power transfer, the switch SW connected in parallel with the capacitor of the resonance coil is set in a conductive state (on state). By so doing, both ends of the capacitor are short-circuited (electrically connected) via the switch SW, charging operation made by the capacitor is not substantially performed in the circuit.

At this time, when the capacitance of the capacitor is C, the reactance and resistance of the coil are respectively L and R, and the connection resistance of the switch SW is Rₒₙ, the resonance frequency fₒₙ and the Q value (Qₒₙ) in this state are respectively expressed by the following mathematical expressions (4) and (5) as shown in the drawing.

fₒₙ=1/(2π\sqrt{L}) (4)

Qₒₙ=ωL/(R+Rₒₙ) (5)

On the other hand, as shown in FIG. 9, when the coil is used for power transfer, the switch SW connected in parallel with the capacitor of the resonance coil is set in a non-conductive state (off state). The resonance frequency f_{off} and the Q value (Q_{off}) in this case are respectively expressed by the following mathematical expressions (6) and (7).

f_{off}=1/{2π(L×C)^{1/2}} (6)

Q_{off}=ωL/R (7)

As is apparent from the above-described mathematical expressions (4) to (7), fₒₙ>f_{off} (=electromagnetic field frequency), and Qₒₙ<Q_{off}. In this way, when the switch SW is turned on, it is possible to shift the resonance frequency from the electromagnetic field frequency, so the coil is hard to resonate with the electromagnetic field, and power transfer is not carried out.

In addition, when the switch is turned off, it is possible to obtain a resonance frequency adapted to a predetermined electromagnetic field frequency, and, in addition, there is no influence of contact resistance component, included in the switch SW, on the Q value.

It is possible to select or not select the coil unit with such a configuration that the above-described switch SW is connected in series with the capacitor and is connected in the case where power transfer is used; however, in that case, when the coil is selected (the switch SW is turned on), the resistance component Rₒₙ of the switch SW is included in the circuit, so the Q value decreases. By so doing, there may occur influence on the power transfer efficiency.

Therefore, as in the case of the first embodiment, by connecting the switch SW in parallel with the capacitor of the coil, it is possible to select or not select the coil, and it is possible to exclude a decrease in the Q value at the time when the coil is selected.

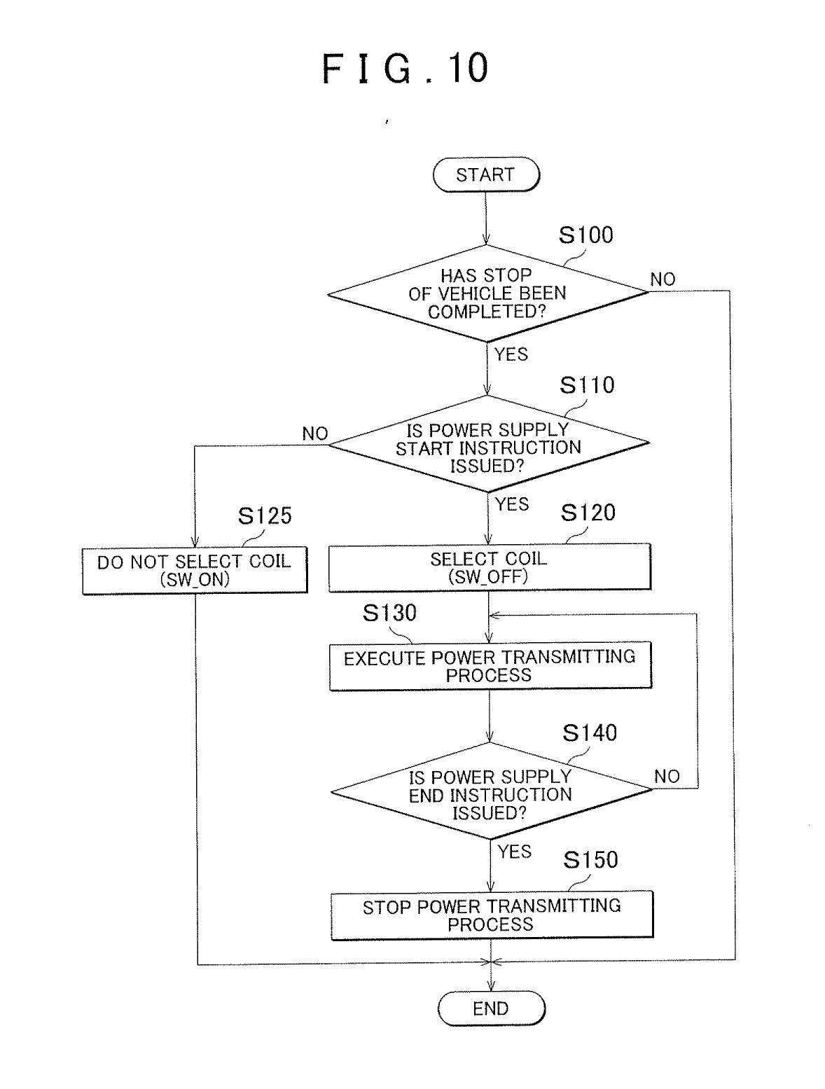

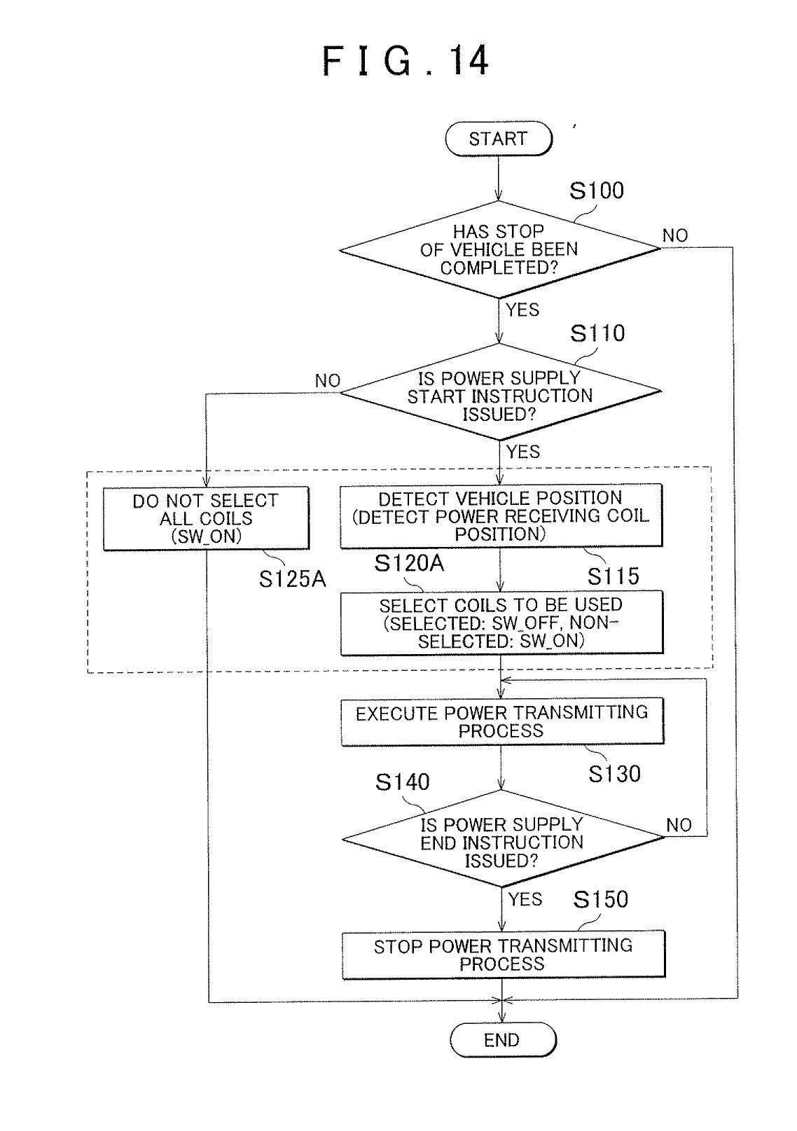

FIG. 10 is a flowchart for illustrating the details of coil selection control process according to the first embodiment. The process of the flowchart in FIG. 10 and the process of the flowchart described later in FIG. 14 are implemented by executing programs prestored in the power transmitting ECU 240 or the vehicle ECU 300 and are called from a main routine at predetermined intervals. Alternatively, for part of steps, the processes may be implemented by constructing exclusive hardware (electronic circuit).

In FIG. 10, description will be made on an example in which the power transmitting switch SW2 is provided in the power transmitting resonance coil 221 included in the power transmitting unit 220 of the power transmitting device 200 shown in FIG. 2 and then the power transmitting switch SW2 is controlled by the power transmitting ECU 240; however, a similar process to the following process is also applicable to the case where the power receiving switch SW1 of the power receiving unit 110 at the vehicle 100 is controlled by the vehicle ECU 300.

In addition, it is also similarly applicable to the case where the power transmitting switch SW2 of the power transmitting unit 220 is controlled by the vehicle ECU 300 to be switched and the case where the power receiving switch SW1 of the power receiving unit 110 is controlled by the power transmitting ECU 240 to be switched.

As shown in FIG. 10, the power transmitting ECU 240 determines in step (hereinafter, step is abbreviated to S) 100 whether the vehicle 100 is stopped at a predetermined stop position.

When a stop of the vehicle 100 has not been completed (NO in S100), power transfer is not carried out, so the following process is skipped, and the power transmitting ECU 240 ends the process.

When a stop of the vehicle 100 has been completed (YES in S100), the process proceeds to S110, and the power transmitting ECU 240 subsequently determines whether a power supply start instruction is issued. The power supply start instruction is issued by an operation signal that is directly input through user's operation or, when timer charging is performed, a start signal that is transmitted from a timer circuit (not shown) in the power transmitting ECU 240 or from the vehicle ECU 300.

When no power supply start instruction is issued (NO in S110), the process proceeds to S125, and the power transmitting ECU 240 sets the power transmitting switch SW2 of the power transmitting unit 220 in an on state, and sets the coil in a non-selected state. By so doing, even when electric power is supplied from the power supply unit 250 to the power transmitting unit 220, the power transmitting resonance coil 221 does not resonate with an electromagnetic field that is generated by the power transmitting electromagnetic induction coil 223, so power transfer to the vehicle 100 is not carried out.

On the other hand, when the power supply start instruction is issued (YES in S110), the process proceeds to S120, and the power transmitting ECU 240 sets the power transmitting switch SW2 of the power transmitting unit 220 in an off state. By so doing, the resonance frequency of the power transmitting resonance coil 221 is set to a resonance frequency that corresponds to the electromagnetic field frequency. By so doing, the power transmitting resonance coil 221 resonates with the electromagnetic field that is generated by the power transmitting electromagnetic induction coil 223, and power transfer is allowed.

Then, in S130, the power transmitting ECU 240 supplies electric power to the power transmitting unit 220 by controlling the power supply unit 250, and executes power transmitting process of transmitting electric power to the vehicle 100.

The power transmitting ECU 240 determines in S140 whether a power supply end instruction has been received from the vehicle ECU 300 through a signal that indicates that the electrical storage device 190 is fully charged, an operation signal from the user, or the like.

When no power supply end instruction has been received (NO in S140), the process returns to S130, and the power transmitting ECU 240 continues power transmitting process until the power supply end instruction is received.

When the power supply end instruction has been received (YES in S140), the process proceeds to S150, and the power transmitting ECU 240 stops supply of electric power from the power supply unit 250 to the power transmitting unit 220, and stops power transmitting process. Although not shown in FIG. 10, as the power transmitting process is stopped in S150, the power transmitting switch SW2 of the power transmitting unit 220 is set in an on state.

As described above, when a counterpart device is caused to perform predetermined operation, for example, when the above-described process is executed in the vehicle ECU 300 and the power transmitting switch SW2 of the power transmitting unit 220 is controlled, an instruction is transmitted from the vehicle ECU 300 to the power transmitting ECU 240 via the communication units 160 and 230 for setting the coil in a selected/non-selected state or executing/stopping the power transmitting process.

By executing control in accordance with the above-described process, in the contactless power supply system in which power transfer is contactlessly carried out, it is possible to appropriately select the coil that is used for power transfer, and it is possible to exclude influence on power transfer by suppressing a decrease in the Q value in the case where power transfer is carried out.

Note that, in the above-described first embodiment, the description is made on the configuration that the switch is switched between a conductive state and a non-conductive state on the basis of whether power transfer is required; however, the configuration does not exclude that it is possible to carry out power transfer even in the case where the switch is in a conductive state (that is, a non-selected state). However, as described above, in a state where the coil is selected, a decrease in the Q value is suppressed and, as a result, the power transfer efficiency is high, so it is desirable to carry out power transfer in a state where the switch is set in a non-conductive state and the coil is selected.

### Alternative Embodiment to First Embodiment

In the above-described first embodiment, the number of switches provided in the resonance coil is one; instead, a plurality of such switches may be provided in the resonance coil.

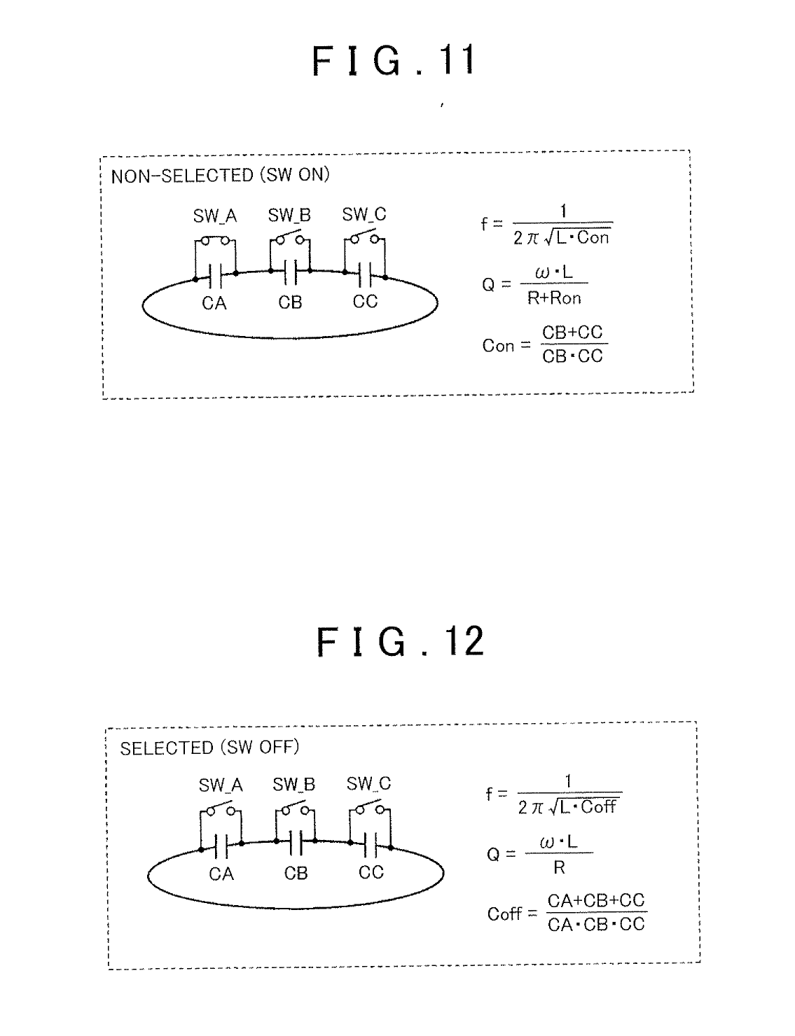

FIG. 11 and FIG. 12 are views, corresponding to FIG. 8 and FIG. 9 in the first embodiment, in the case where three switches SW_A, SW_B and SW_C respectively connected in parallel with three capacitors are provided in a resonance coil that includes the three capacitors.

In this case as well, when the coil is not used for power transfer (FIG. 11), at least one switch is set in an on state. By so doing, it is possible to shift the resonance frequency of the resonance coil from the electromagnetic field frequency.

In addition, when the coil is used for power transfer (FIG. 12), all the switches are set in an off state. By so doing, it is possible to set the resonance frequency of the resonance coil to a frequency that is adapted to (that coincides with) the electromagnetic field frequency, and, furthermore, it is possible to exclude the influence of resistance components of the switches on the Q value.

### Second Embodiment

In the first embodiment and the alternative embodiment to the first embodiment, the description is made on the configuration that the selected coil is switched depending on whether power supply is carried out in the case where the number of the resonance coils of the power transmitting device and the number of the resonance coils of the power receiving device (vehicle) each are one.

Incidentally, as described above, in the contactless power supply system, the power transfer efficiency is influenced by a positional deviation between the power transmitting resonance coil and the power receiving resonance coil. Therefore, when the vehicle is stopped above the power transmitting unit of the power transmitting device, it is required to adjust the stop position such that the position of the power transmitting unit coincides with the position of the power receiving unit.

However, it is difficult to stop the vehicle such that the position of the power transmitting unit completely coincides with the position of the power receiving unit, and, in addition, depending on a position of the power receiving unit mounted on the vehicle, it may not be possible to completely match the position of the power receiving unit with the position of the power transmitting unit.

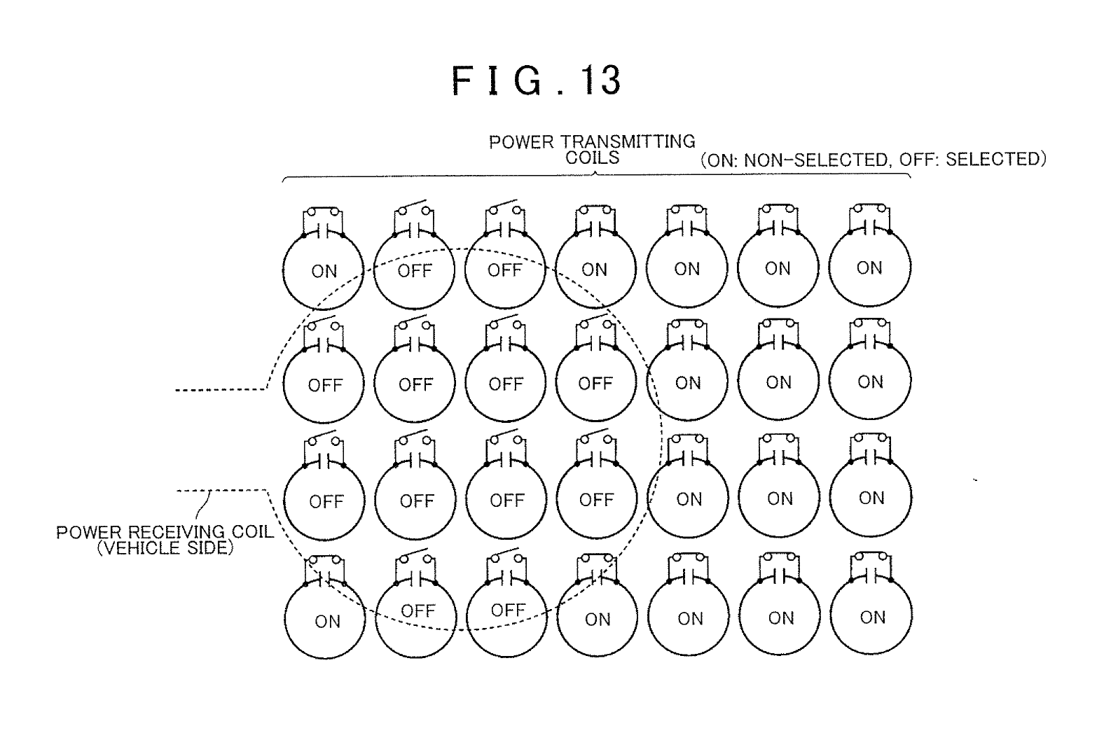

In order to take measures against such problems, as shown in FIG. 13, a method of relieving positioning accuracy as described above by providing a plurality of resonance coils in the power transmitting unit of the power transmitting device may be employed. In this case, among the plurality of resonance coils in the power transmitting device, if electric power is also transmitted from the resonance coils outside a power receiving range corresponding to the power receiving unit of the power receiving device, there may occur a decrease in the overall transfer efficiency, an increase in leakage of electromagnetic field and interference in electromagnetic field between the resonance coils that actually contribute to power transfer and the resonance coils that do not contribute to power transfer.

Therefore, in the second embodiment, in a configuration that a plurality of resonance coils are included in at least one of a power transmitting side and a power receiving side, as shown in FIG. 13, only the resonance coils within a range that actually contributes to power transfer are selected and the resonance coils within the other range are not selected. Then, selection of the resonance coils is performed by controlling switches connected in parallel with capacitors of the respective resonance coils as in the case of the first embodiment.

With the above configuration, it is possible to relieve positioning accuracy between the power transmitting unit and the power receiving unit while suppressing influence on power transfer.

FIG. 13 shows an example in which a plurality of power transmitting resonance coils are provided; instead, a plurality of power receiving resonance coils may be provided against a single power transmitting resonance coil. In addition, both the power transmitting side and the power receiving side may include a plurality of resonance coils and then power transfer may be carried out by selecting only the resonance coils within a mutually overlapped range.

FIG. 14 is a flowchart for illustrating coil selection control that is executed in a contactless power supply system according to the second embodiment. The flowchart shown in FIG. 14 differs from the flowchart shown in FIG. 10 according to the first embodiment in that S115, S120A and S125A are added instead of S120 and S125. In FIG. 14, the description of steps that overlap with the steps of FIG. 10 is not repeated.

In FIG. 14, description will be made on an example in which a plurality of resonance coils are provided in the power transmitting unit, and, as in the case of the description with reference to FIG. 10, the coil selection control is executed by the ECU of the power transmitting device; however, the control is applicable to a configuration that a plurality of resonance coils are provided in at least one of the power transmitting side and the power receiving side. Thus, a plurality of resonance coils may be provided in both the power transmitting side and the power receiving side. In addition, the control may be executed by any of the power transmitting ECU and the power receiving ECU.

As shown in FIG. 14, when the vehicle is stopped such that the power receiving unit 110 of the vehicle 100 is located within a range in which the power transmitting unit 220 is able to transmit electric power (YES in S100), the power transmitting ECU 240 determines in S110 whether a power supply start instruction has been received.

When the power supply start instruction has not been received (NO in S110), the process proceeds to S125A, and the power transmitting ECU 240 sets all the switches of the plurality of resonance coils included in the power transmitting unit 220 in an off state, and then ends the process.

When the power supply start instruction has been received (YES in S110), the process proceeds to S115, and the power transmitting ECU 240 detects the stop position of the vehicle, that is, the position of the resonance coil 111 of the power receiving unit 110.

Then, in S120A, the power transmitting ECU 240 sets the switches of the resonance coils of the power transmitting unit 220, corresponding to the detected position of the resonance coil 111, in an off state, and selects those resonance coils as the resonance coils that are used for power transfer. Furthermore, the power transmitting ECU 240 sets the switches of the resonance coils that are not used for power transfer in an on state, and sets those resonance coils in a non-selected state. Note that, when a plurality of resonance coils are provided in both the power transmitting side and the power receiving side, for example, the resonance coils at a portion at which a power transmitting range and a power receiving range overlap with each other are selected as the resonance coils that are used for power transfer.

After that, the power transmitting ECU 240 continues the power transmitting process until a power supply end instruction is received (S130 to S150).

By executing control in accordance with the above-described process, in the contactless power supply system that includes the plurality of resonance coils in at least one of the power transmitting device and the power receiving device, it is possible to appropriately select the resonance coils that are used for power transfer and to suppress the influence of the non-selected resonance coils on power transfer.

In addition, as shown in FIG. 13, by providing the plurality of resonance coils, electric power loaded on each resonance coil is distributed, so it is possible to decrease the withstanding voltage of each of the capacitors provided in the resonance coils.

Furthermore, when electric power is transferred from a single power transmitting device to a plurality of power receiving devices, it is possible to generate an electromagnetic field only at a location of a predetermined intended power receiving device.

In addition, when power transfer is carried out, it is possible to suppress “hopping” that electric power propagates to the resonance coils that actually do not contribute to power transfer, so it is possible to suppress a decrease in transfer efficiency.

Furthermore, in the above-described embodiment, coils are selected by detecting the position of the vehicle; however, instead of detecting the position of the vehicle, selected coils may be determined on the basis of a transfer efficiency.

The embodiments described above are illustrative and not restrictive in all respects. The scope of the invention is defined by the appended claims rather than the above description. The scope of the invention is intended to encompass all modifications within the scope of the appended claims and equivalents thereof.

What is claimed is:

1. A contactless power receiving device comprising:
a power receiving unit that contactlessly receives electric power from a power transmitting unit provided in a power transmitting device, and that includes: a first coil; a first capacitor that is connected to the first coil; and a first selector device that is connected in parallel with the first capacitor and that is configured to be switched between a connecting state in which the first selector device electrically connects both ends of the first capacitor and a disconnecting state in which the first selector device electrically disconnects the both ends of the first capacitor; and
an electric load device that uses the electric power received by the power receiving unit.

2. The contactless power receiving device according to claim 1, wherein the power receiving unit receives electric power from the power transmitting unit in a state where the first selector device is set in the disconnecting state.

3. The contactless power receiving device according to claim 1, further comprising:
a control unit that sets the first selector device in the disconnecting state when electric power is received from the power transmitting unit.

4. The contactless power receiving device according to claim 1, wherein the power receiving unit further includes: a second coil; a second capacitor that is connected to the second coil; and a second selector device that is connected in parallel with the second capacitor and that is configured to be switched between a connecting state in which the second selector device electrically connects both ends of the second capacitor and a disconnecting state in which the second selector device electrically disconnects the both ends of the second capacitor.

5. The contactless power receiving device according to claim 4, further comprising:
a control unit that sets one of the first selector device and the second selector device, corresponding to one of the first coil and the second coil, which is used to receive electric power, in the disconnecting state.

6. The contactless power receiving device according to claim 5, wherein the control unit selects the one of the first coil and the second coil, which is used to receive electric power, on the basis of a position of the power transmitting unit and a position of the power receiving unit.

7. The contactless power receiving device according to claim 3, wherein the control unit sets one of the first selector device and the second selector device, corresponding to one of the first coil and the second coil, which is not used to receive electric power, in the connecting state.

8. The contactless power receiving device according to claim 1, wherein a difference between a natural frequency of the power transmitting unit and a natural frequency of the power receiving unit is smaller than or equal to ±10% of the natural frequency of one of the power transmitting unit and the power receiving unit.

9. The contactless power receiving device according to claim 1, wherein a coupling coefficient between the power transmitting unit and the power receiving unit is smaller than or equal to 0.1.

10. The contactless power receiving device according to claim 1, wherein:
the power receiving unit receives electric power from the power transmitting unit through at least one of a magnetic field and an electric field;
the magnetic field is formed between the power receiving unit and the power transmitting unit and oscillates at a specific frequency; and
the electric field is formed between the power receiving unit and the power transmitting unit and oscillates at the specific frequency.

11. The contactless power receiving device according to claim 1, wherein:
the power receiving unit further includes: a third capacitor that is connected in series with the first capacitor; and a third selector device that is connected in parallel with the third capacitor and that is configured to be switched between a connecting state in which the third selector device electrically connects both ends of the third capacitor and a disconnecting state in which the third selector device electrically disconnects the both ends of the third capacitor; and
the power receiving unit receives electric power from the power transmitting unit in a state where the first selector device and the third selector device are set in the disconnecting state.

12. A contactless power transmitting device comprising:
a power transmitting unit that contactlessly transmits electric power to a power receiving unit provided in a power receiving device, and that includes: a fourth coil; a fourth capacitor that is connected to the fourth coil; and a fourth selector device that is connected in parallel with the fourth capacitor and that is configured to be switched between a connecting state in which the fourth selector device electrically connects both ends of the fourth capacitor and a disconnecting state in which the fourth selector device electrically disconnects the both ends of the fourth capacitor; and
a power supply unit that supplies electric power to the power transmitting unit.

13. The contactless power transmitting device according to claim 12, wherein the power transmitting unit transmits electric power to the power receiving unit in a state where the fourth selector device is in the disconnecting state.

14. The contactless power transmitting device according to claim 12, wherein the power transmitting unit further includes: a fifth coil; a fifth capacitor that is connected to the fifth coil; and a fifth selector device that is connected in parallel with the fifth capacitor and that is configured to be switched between a connecting state in which the fifth selector device electrically connects both ends of the fifth capacitor and a disconnecting state in which the fifth selector device electrically disconnects the both ends of the fifth capacitor.

15. The contactless power transmitting device according to claim 14, further comprising:
a control unit that sets one of the fourth selector device and the fifth selector device, corresponding to one of the fourth coil and the fifth coil, which is used to transmit electric power, in the disconnecting state.

16. The contactless power transmitting device according to claim 15, wherein the control unit selects the one of the fourth coil and the fifth coil, which is used to transmit electric power, on the basis of a position of the power transmitting unit and a position of the power receiving unit.

17. The contactless power transmitting device according to claim 12, wherein a difference between a natural frequency of the power transmitting unit and a natural frequency of the power receiving unit is smaller than or equal to ±10% of the natural frequency of one of the power transmitting unit and the power receiving unit.

18. The contactless power transmitting device according to claim 12, wherein a coupling coefficient between the power transmitting unit and the power receiving unit is smaller than or equal to 0.1.

19. The contactless power transmitting device according to claim 12, wherein:
the power transmitting unit transmits electric power to the power receiving unit through at least one of a magnetic field and an electric field;
the magnetic field is formed between the power receiving unit and the power transmitting unit and oscillates at a specific frequency; and
the electric field is formed between the power receiving unit and the power transmitting unit and oscillates at the specific frequency.

20. A vehicle comprising:
a power receiving unit that contactlessly receives electric power from a power transmitting unit provided in a power transmitting device, and that includes: a coil; a capacitor that is connected to the coil; and a selector device that is connected in parallel with the capacitor and that is configured to be switched between a connecting state in which the selector device electrically connects both ends of the capacitor and a disconnecting state in which the selector device electrically disconnects the both ends of the capacitor; and
an electric load device that uses the electric power received by the power receiving unit.

21. A contactless power supply system comprising:
a power transmitting unit that is provided in a power transmitting device and that includes a plurality of coil units;
a power receiving unit that is provided in a vehicle; and
a control unit, wherein:
each of the plurality of coil units includes: a coil; a capacitor that is connected to the coil; and a selector device that is connected in parallel with the capacitor and that is configured to be switched between a connecting state in which the selector device electrically connects both ends of the capacitor and a disconnecting state in which the selector device electrically disconnects the both ends of the capacitor;
the control unit selects at least one of the coil units, which is used to transmit electric power, from among the plurality of coil units on the basis of a position of the power transmitting unit and a position of the power receiving unit; and
the control unit executes control such that the selector device corresponding to the at least one selected coil unit is set in the disconnecting state and the selector device corresponding to the non-selected coil unit is set in the connecting state.

22. A contactless power supply system comprising:
a power transmitting unit that is provided in a power transmitting device;
a power receiving unit that is provided in a vehicle and that includes a plurality of coil units; and
a control unit, wherein:
each of the plurality of coil units includes: a coil; a capacitor that is connected to the coil; and a selector device that is connected in parallel with the capacitor and that is configured to be switched between a connecting state in which the selector device electrically connects both ends of the capacitor and a disconnecting state in which the selector device electrically disconnects the both ends of the capacitor;
the control unit selects at least one of the coil units, which is used to receive electric power, from among the plurality of coil units on the basis of a position of the power transmitting unit and a position of the power receiving unit; and
the control unit executes control such that the selector device corresponding to the at least one selected coil unit is set in the disconnecting state and the selector device corresponding to the non-selected coil unit is set in the connecting state.
